(19) United States
(12) Patent Application Publication
(10) Pub. No.: US 2017/0021786 A1
(43) Pub. Date: Jan. 26, 2017

(54) INTERLOCKING MULTIPIECE VEHICLE FRONT END PROTECTIVE DEVICE

(71) Applicant: AUTOMOTIVE ACCENTS LLC, Cleveland, TN (US)

(72) Inventor: Hyung Jin LEE, Edmonton (CA)

(21) Appl. No.: 14/807,166

(22) Filed: Jul. 23, 2015

(51) Int. Cl. B60R 19/02; B60R 19/24

(52) U.S. Cl. CPC B60R 19/023; B60R 19/24

(57) ABSTRACT

An interlocking multipiece vehicle shield is assembled from plural pieces which are joined edgewise, for example by studs and apertures having a snap-together feature. The pieces are designed so that the assembled shield conforms to the shape of the front end of a particular vehicle. The shield is secured to the vehicle by adhesive tape applied around the periphery of the shield.

### BACKGROUND OF THE INVENTION

This invention relates to a shield for protecting the front end or hood of a vehicle from damage by road debris.

Accessory shields and airflow deflectors, which one can attach to the front end of a car or truck to protect it from bugs, dirt, gravel and the like, are well known. Some shields are made of fabric; these are commonly called “bras”. Others are substantially rigid, better able to protect the vehicle from stone impacts, to redirect airflow and to prevent hood flutter.

Some prior rigid shields extend substantially the width of the vehicle; such shields are quite bulky, and therefore require large containers which are costly to ship and difficult to store.

Single-piece front end shields are not easy to repair, and if damaged, must often be replaced.

### SUMMARY OF THE INVENTION

An object of the invention is to reduce shield shipping and storage costs.

A further object is to provide a product which is easy to handle and install, and which can be more easily repaired and customized.

These and other objects are attained by the invention described below.

The shield described herein is an assembly of multiple pieces which are aligned, interconnected, and then attached to the vehicle's surface. Each piece has multiple, integrally formed connecting and aligning structures, for example, posts or tabs on one part which fit into slots or apertures on an adjacent part. The pieces may also, or alternatively, have tongue and groove connections, where a tongue from one piece fits into a corresponding groove located on another piece of the assembly. Once these interlocking structures are engaged, the resulting assembly provides a stable front end shield.

The invention, because it is made in several pieces, can be shipped in much smaller packaging than can a traditional one-piece shield. This, in turn, reduces transportation costs at multiple levels, including shipping from the manufacturer to the warehouse distributor, shipping from the warehouse distributor to the reseller, and delivery to the end user.

The invention also occupies less shelf space, making it more attractive for retailers to keep in stock.

The assembled shield may be attached to the vehicle with two-sided tape. Because it is attached to the vehicle surface, and does not fit between the hood and the grille as some one-piece shields do, successful installation does not depend on tight and variable clearances between parts of the vehicle such as between the hood and the grille.

The shield does not require tools for assembly or installation, making it suitable for cash-and-carry sale and do-it-yourself installation.

The invention allows the end user to mix and match the colors or finish (e.g., surface texture) of the pieces which form the assembly to further create a truly custom look, and to enhance the appearance of the vehicle. For example, for vehicles with chrome factory grilles, one might install a chrome finished center piece with two smoke-in-color wings on the left and right sides of the center piece. For vehicles with black factory grilles, one could install a smoke-in-color center piece with chrome wings on the left and right.

The invention makes it easier for a customer to apply its logo, as it need alter only one of the several pieces which form the assembly.

Because the invention is made from multiple pieces, in the event that the shield gets damaged, only the damaged component need be replaced.

A further advantage is that, as the invention requires less packaging than a one-piece protector, and can more likely be repaired if damaged, it has reduced environmental impact.

### BRIEF DESCRIPTION OF THE DRAWINGS

The drawings show a protective device designed for the 2015 Ford F150 truck.

FIG. 1 is an exploded perspective view of a truck hood, and an interlocking multipiece vehicle front end protective device embodying the invention.

FIG. 2 is an assembled view of the protective device.

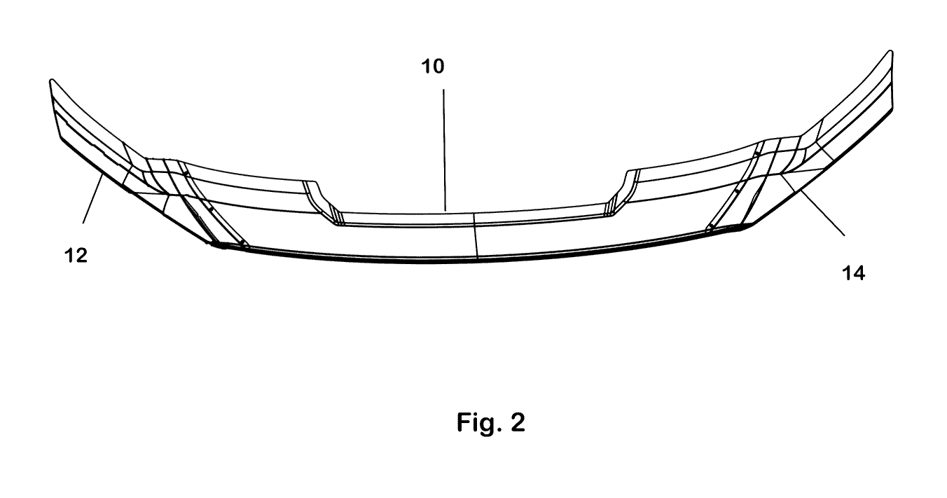

FIG. 3 is a detailed perspective view of one lateral panel of the invention.

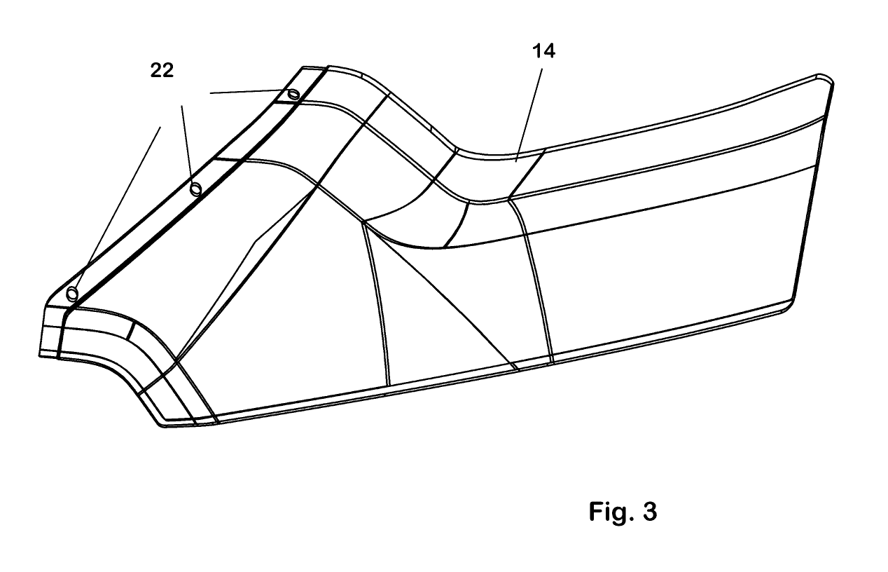

FIG. 4 shows the mating edges of the center panel and one lateral panel.

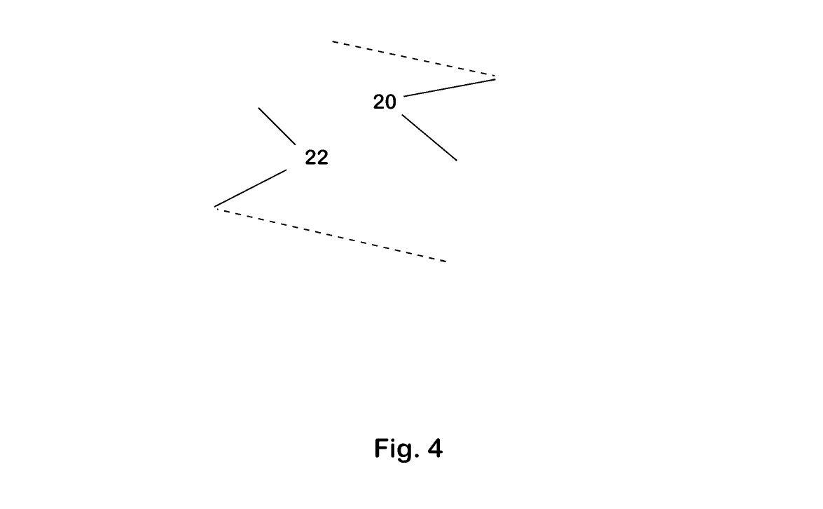

FIG. 5 is a top plan view of the invention, installed on the truck hood.

FIG. 6 is a sectional view through the protective device, showing an adhesive tape attaching one panel to the hood (the thickness of the tape is exaggerated).

FIG. 7 is a bottom view of the center panel, showing tape applied around the entire periphery of the panel, prior to installation on the vehicle hood.

FIG. 8 is a bottom view of a lateral panel, showing the tape application pattern.

### DESCRIPTION OF THE PREFERRED EMBODIMENT

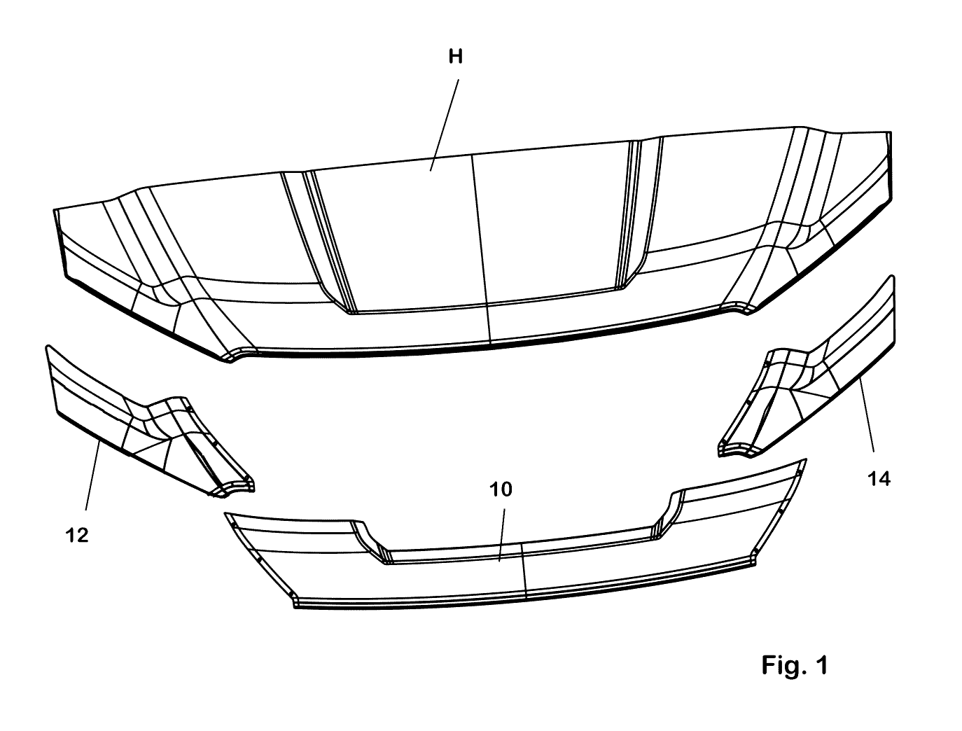

An example of a device embodying the invention is shown in the exploded view of FIG. 1. The device comprises three major components: a center panel 10 which is shaped to conform to a portion of the vehicle hood “H”, and two lateral panels 12 and 14 which can be joined to the center panel, forming an assembly nearly as wide as the front end of the vehicle. While there are three components in this example, another number of pieces might be used, hence, the word “plurality” in the claims below.

The three components have connecting structures which enable them to be inter-locked to form a stable assembly. These structures may be, for example, posts 20 and corresponding apertures 22 on adjacent parts. In the embodiment illustrated, there are six posts on the center piece and three apertures on each of the two side pieces. However, different numbers and styles of interlocking structures may be used, depending on the application.

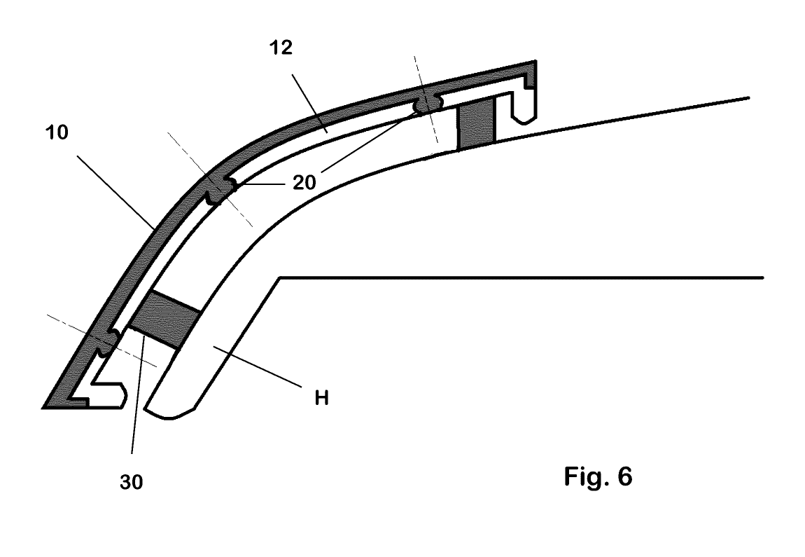

The connecting structures are preferably disconnectable without damage, so that the assembly can be reconstructed when desired, for example, to customize or repair the shield. FIG. 6 shows a preferred form in which the posts 20 are barrel-shaped to provide a snap-connection with the apertures 22, which have a complementary shape. The radius of the barrel surface is exaggerated in FIG. 6.

While posts and apertures are illustrated, it should be understood that other connecting structures may be used instead of, or in addition to, the posts and apertures. For example, the connecting structures might be in the form of interlocking tongues and grooves, zipper-like structures, Velcro, etc. Some such alternatives may prove to be as good as or even better than the structures presently contemplated.

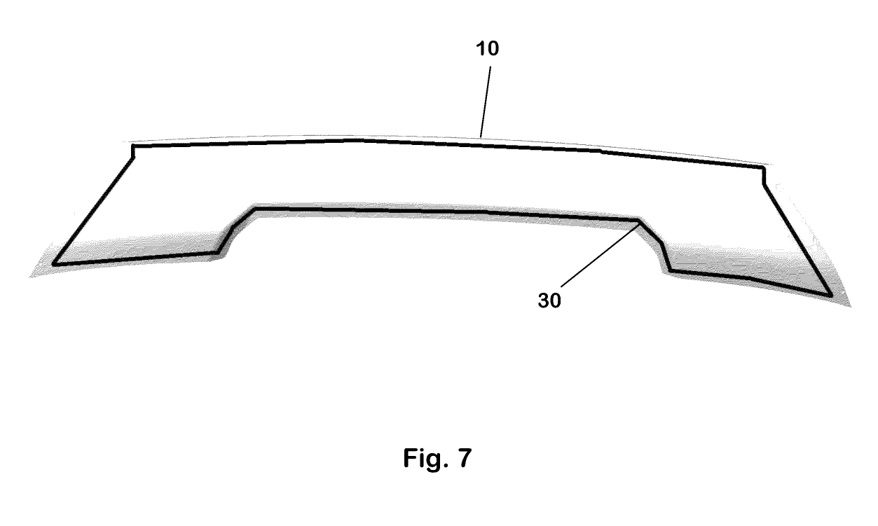

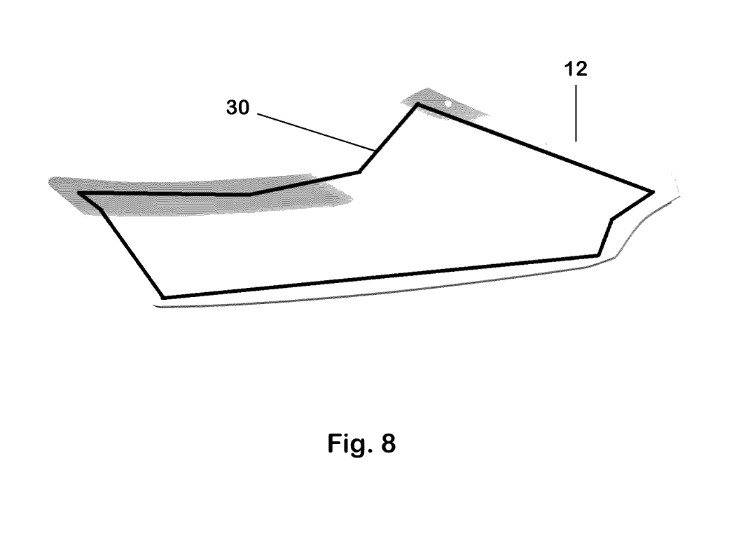

The assembled shield is attached to the vehicle's body by means of double-sided adhesive foam tape 30 (FIGS. 6-8). Preferably, as seen in FIGS. 7 and 8, the tape is continuous and extends along the entire periphery of the assembled shield. The choice of tape and adhesive are a matter of design choice, many suitable materials being commercially available.

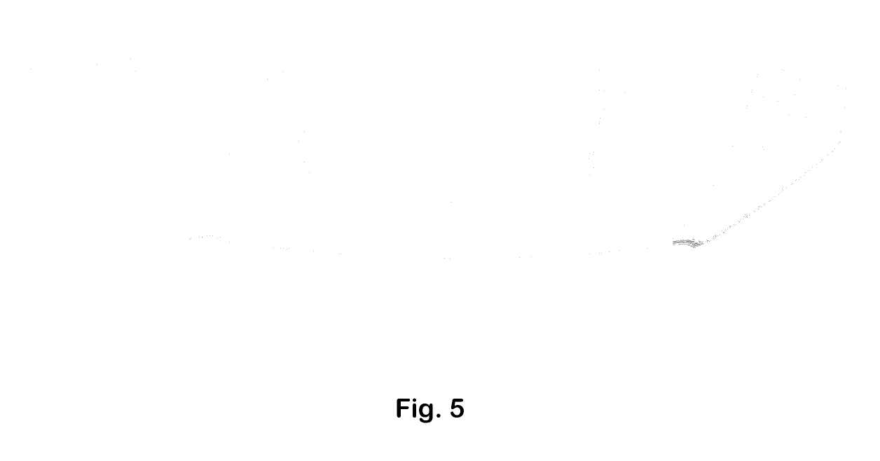

An advantage of the invention mentioned above is that the hood shield may be customized by mixing and matching components of different colors and/or textures. The illustration of FIG. 5 shows center and lateral panels in different shades of gray, representing either different colors or different textures.

It should be understood that the device illustrated and described above is only one example, as the shape and arrangement of the pieces will vary from vehicle to vehicle; however, the principles of the invention remain the same.

Since the invention is subject to modifications and variations, it is intended that the foregoing description and the accompanying drawings shall be interpreted as only illustrative of the invention defined by the following claims.

I claim:

1. A protective device for installation on the front end of a motor vehicle, said device comprising
a plurality of pieces, each shaped to conform to a contour of a respective underlying component of the vehicle,
each of said pieces having connecting structure for joining that piece to at least one neighboring said piece, and
means for connecting each said piece to an underlying component of the vehicle.

2. The device of claim 1, wherein the connecting structure is an adhesive connector.

3. The device of claim 2, wherein the adhesive connector comprises foam tape having adhesive on both faces thereof.

4. The device of claim 1, wherein said connecting structure comprises mating male and female fasteners.

5. The device of claim 4, wherein said male and female fasteners are formed integrally with said pieces.

6. The device of claim 5, wherein said male fasteners are studs and said female fasteners are apertures sized to receive said studs.

7. The device of claim 6, wherein at least one of said studs and said apertures has structure which provides a snap connection.

8. The device of claim 4, wherein said structures can be disconnected without damage.

9. The device of claim 1, wherein each of said pieces is made from a polymeric material.

10. The device of claim 1, wherein at least two of said pieces are of different colors.

11. The device of claim 1, wherein at least two of said pieces have different surface textures.
